(19) United States
(12) Patent Application Publication
(10) Pub. No.: US 2023/0298550 A1
(43) Pub. Date: Sep. 21, 2023

(54) MANIPULATOR FOR ELECTRONIC MUSICAL INSTRUMENTS

(71) Applicant: CASIO COMPUTER CO., LTD., Tokyo (JP)

(72) Inventors: Otoya SAKAI, Tokyo (JP); Takahiro MORIYA, Tokyo (JP); Hirokatsu KATOH, Kanagawa (JP)

(73) Assignee: CASIO COMPUTER CO., LTD., Tokyo (JP)

(21) Appl. No.: 18/183,611

(22) Filed: Mar. 14, 2023

(30) Foreign Application Priority Data
Mar. 15, 2022 (JP) 2022-039928

(51) Int. Cl. G10H 1/34; F21V 8/00; G10H 1/14; G10H 1/00

(52) U.S. Cl. CPC G10H 1/34; G02B 6/0055; G02B 6/0068; G10H 1/14; G10H 1/0008; G10H 2210/325; G10H 2220/026; G10H 2220/265

(57) ABSTRACT

A manipulator, comprises a light source that emits light; and an operation member rotationally operatable around an axis by a user, the operation member having a substantially disk shape and including a light guide member that guides light incident from the light source and emits the light to an outside in radical directions of the substantially disk shape from an outer peripheral portion thereof, and a reflecting member reflecting a portion of the light guided by the light guide member in a direction perpendicular to the radial directions at said outer peripheral portion.

### BACKGROUND OF THE INVENTION

### Technical Field

The present invention relates to a manipulator for performance control in electronic musical instruments and electronic musical instruments.

### Background Art

Conventionally, electronic musical instruments such as electronic pianos are known to have a manipulator for imparting performance effects such as pitch bend to musical tones. An electronic musical instrument of this type has been proposed which has a light-emitting section and changes the light-emitting status of the light-emitting section in accordance with the operation of the operator, that is, the control status of the performance effect.

For example, Japanese Unexamined Patent Application Publication No. 2007-248734 discloses an electronic keyboard instrument in which any key can be designated as an operator for imparting performance effects to musical tones. In this electronic keyboard instrument, a blue LED and a red LED are embedded in each translucent key, and the light emission status of each LED changes according to the control status of the performance effect.

### SUMMARY OF THE INVENTION

Features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a manipulator, comprising a light source that emits light; and an operation member rotationally operatable around an axis by a user, the operation member having a substantially disk shape and including a light guide member that guides light incident from the light source and transmits the light to an outside in radical directions of the substantially disk shape from an outer peripheral portion thereof, and a reflecting member reflecting a portion of the light guided by the light guide member in a direction perpendicular to the radial directions at said outer peripheral portion.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is an overall perspective view of an electronic keyboard instrument according to an embodiment.

FIG. 2 is a perspective view of the left case of the electronic keyboard instrument according to the embodiment, viewed from the right side.

FIG. 3 is a perspective view of a pitch bender according to the embodiment as seen from the front right side.

FIG. 4 is a perspective view of the pitch bender according to the embodiment as seen from the front left side.

FIG. 5 is an exploded perspective view of the pitch bender according to the embodiment.

FIG. 6 is a side view of the operation wheel of the pitch bender according to the embodiment as seen from the right side, and is a side view showing the manner of rotation of the operation wheel.

FIG. 7 is a perspective view of a wheel member of the pitch bender according to the embodiment;

FIG. 8 is a cross-sectional view of the pitch bender according to the embodiment, and is a cross-sectional view of the VIII-VIII cross section in FIG. 3.

FIG. 9 is a side view of the operation wheel of the pitch bender according to the embodiment as seen from the right side, and is a side view showing how light is guided in the light guide member.

FIG. 10 is a cross-sectional view of the pitch bender according to the embodiment, and is a cross-sectional view of the X-X cross section in FIG. 3.

### DETAILED DESCRIPTION OF EMBODIMENTS

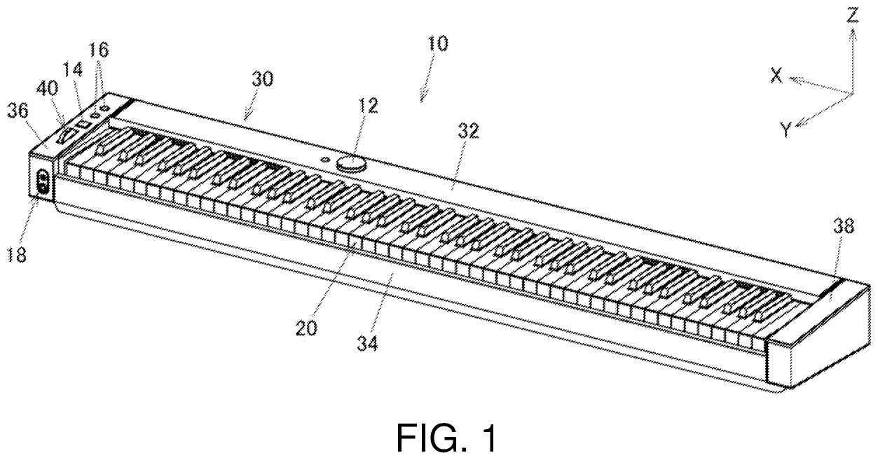

An embodiment of the present invention will be described with reference to the drawings. An electronic keyboard instrument (electronic musical instrument) 10 shown in FIG. 1 includes a keyboard 20 having a plurality of white keys and a plurality of black keys, and a case 30. A control board and the like are accommodated inside the case 30.

Each figure shows coordinate axes; the X-axis direction in each figure is the left-right direction of the electronic keyboard instrument 10 (the positive direction of the X-axis is the left direction); the Y-axis direction in each figure is the front-rear direction of the keyboard instrument 10 (the positive direction of the Y-axis is defined as the front direction); and the Z-axis direction in each figure is the vertical direction of the electronic keyboard instrument 10 (the positive direction of the Z-axis is defined as the upward direction).

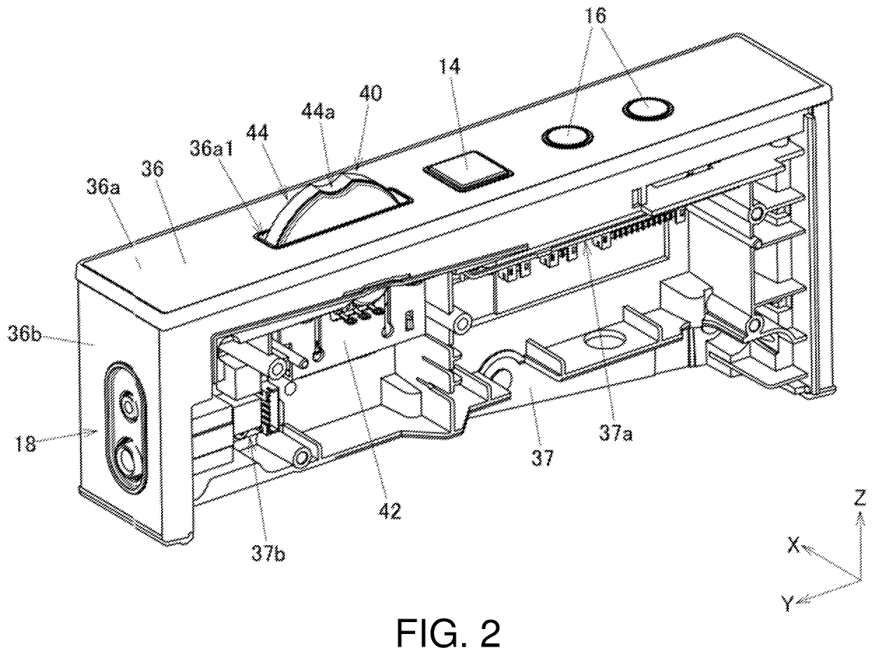

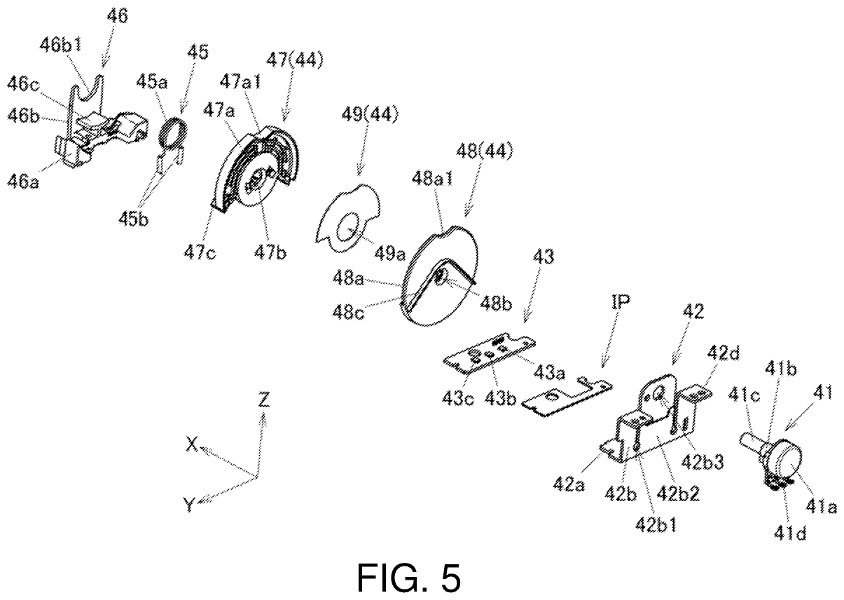

The case 30 has a horizontally long rectangular shape with the left-right direction as the longitudinal direction, is made of synthetic resin, and is divided into an upper case 32, a lower case 34, a left case 36, and a right case 38. A part of the upper surface of the upper case 32 is provided with a dial 12 for controlling the volume of musical tones. As shown in FIG. 2, the left case 36 has a top panel 36a forming its upper surface and a case side wall 36b forming its side wall. The front portion of the top panel 36a is provided with an operation opening 36a1 through which a portion of a pitch bender (manipulator) 40 (an operation wheel 44, which will be described later) is exposed for imparting pitch bend to musical tones and controlling the pitch bend. On the rear side of the top panel 36a, there are provided a light emission button 14 for starting or stopping the emission of each of the LEDs 43a to 43c (see FIG. 5, etc.) provided in the pitch bender 40, and setting buttons 16 for various settings. An earphone jack 18 is provided on the front surface of the case side wall 36b.

An internal frame 37 that is a frame-shaped member is provided on the inner surface side of the left case 36. Inside the internal frame 37, a first substrate 37a for accepting pressing operations of the light emission button 14 and the setting buttons 16, a second substrate 37b for accepting insertion/removal operations of the earphone jack 18, a pitch bender 40, and the like are attached. The first substrate 37a and the second substrate 37b and the first substrate 37a and the pitch bender 40 are electrically connected by connection wirings (not shown). Also, the first substrate 37a and the second substrate 37b are electrically connected to the control board of the electronic keyboard instrument 10 by connection wirings (not shown).

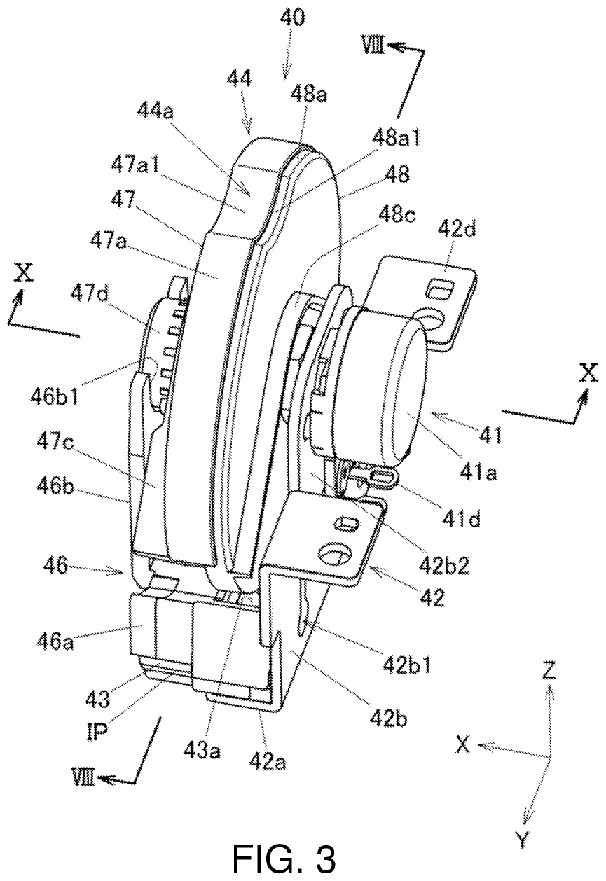

The configuration of the pitch bender 40 will be explained in detail. As shown in FIGS. 3 to 5, the pitch bender 40 includes a variable resistor 41, a fixing metal fitting 42, a light source substrate 43, an operation wheel (operation member) 44, a torsion spring 45, and a holding member 46. The operation wheel 44 has a substantially disk shape, and has a wheel member 47, a light guide member 48, and a double-sided adhesive tape 49 for adhering the wheel member 47 and the light guide member 48 together (see FIG. 5). The upper portion of the operation wheel 44 is exposed through the operation opening 36a1 of the left case 36.

The variable resistor 41 is a rotatable rotary-type variable resistor that detects a rotation angle, and includes a sensor front portion 41a, a sensor rear portion 41b, a shaft-shaped member 41c, and three wiring connection parts 41d extending from the lower side of the sensor front portion 41a. The sensor front portion 41a has a substantially circular columnar shape, and the sensor rear portion 41b has a substantially cylindrical shape that is narrower than the sensor front portion 41a and protrudes leftward from the left side of the sensor front portion 41a. The sensor front portion 41a and the sensor rear portion 41b constitute a rotation angle sensor.

The shaft-shaped member 41c extends axially along the left-right direction, and the right end thereof is inserted into the cylindrical inner side of the sensor rear portion 41b so as to be rotatable around the axis. The shaft-shaped member 41c has a substantially half-moon cross section at a portion exposed from the sensor rear portion 41b except for the vicinity of the boundary portion with the sensor rear portion 41b. A connection wiring connected to the first substrate 37a is connected to each of the wiring connection parts 41d. The variable resistor 41 detects the rotation angle of the shaft-shaped member 41c from the resistance value that changes according to the rotation of the shaft-shaped member 41c with respect to the sensor front portion 41a and the sensor rear portion 41b, converts the rotation angle into an electric signal, and outputs the electrical signal to the first substrate 37a through the connection wirings.

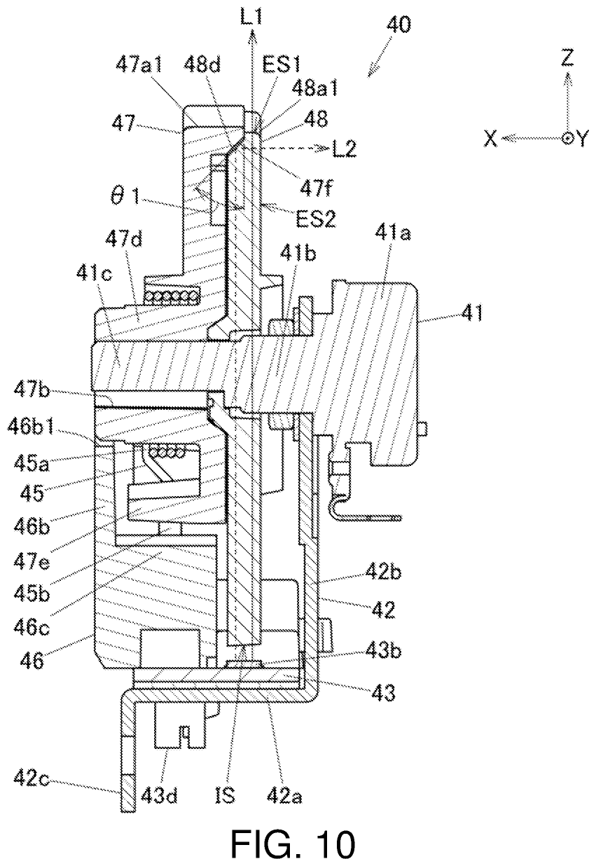

The fixing metal fitting 42 is a metal fitting for fixing respective members constituting the pitch bender 40 to each other and for fixing the pitch bender 40 to the inner frame 37, and has a substantially L-shaped cross section (see FIG. 10). The fixing metal fitting 42 includes a flat plate portion 42a arranged with its plate surfaces facing in the vertical directions, and a standing wall 42b rising from the right end of the flat plate portion 42a in a flat plate shape with its plate surfaces facing in the horizontal directions. The fixing metal fitting 42 includes a first screwing portion 42c extending downward from a part of the left end portion of the flat plate portion 42a, and second screwing portions 42d extending rightward from respective front and rear ends of the rising tip portion of the standing wall portion 42b. The fixing metal fitting 42 is fixed to the inner frame 37 by screwing the first screwing portion 42c and the second screwing portions 42d to the inner frame 37, respectively.

A pair of slits 42b1 that are open upward and extend in the vertical direction are provided at respective inner sides of the vertical wall portion 42b from which the two second screwing portions 42d extend. At the inner sides relative to the two slits 42b1, a plate-shaped resistor fixing portion 42b2 is provided, extending upward from the height position of the two second screwing portions 42d. In the resistor fixing portion 42b2, a circular opening 42b3, through which the sensor rear portion 41b of the variable resistor 41 is inserted, is formed in a portion positioned above the two second screwing portions 42d. The variable resistor 41 is coupled to the resistor fixing portion 42b2 by bolting with the sensor rear portion 41b inserted into the fixing opening 42b3. With the slits 42b1 provided on both sides of the resistor fixing portion 42b2, the resistor fixing portion 42b2 is more flexible than other parts of the fixing metal fitting 42 in a horizontal direction (i.e., the direction of the axis of the shaft-shaped member 41c) in a state where the fixing metal fitting 42 is fixed to the inner frame 37.

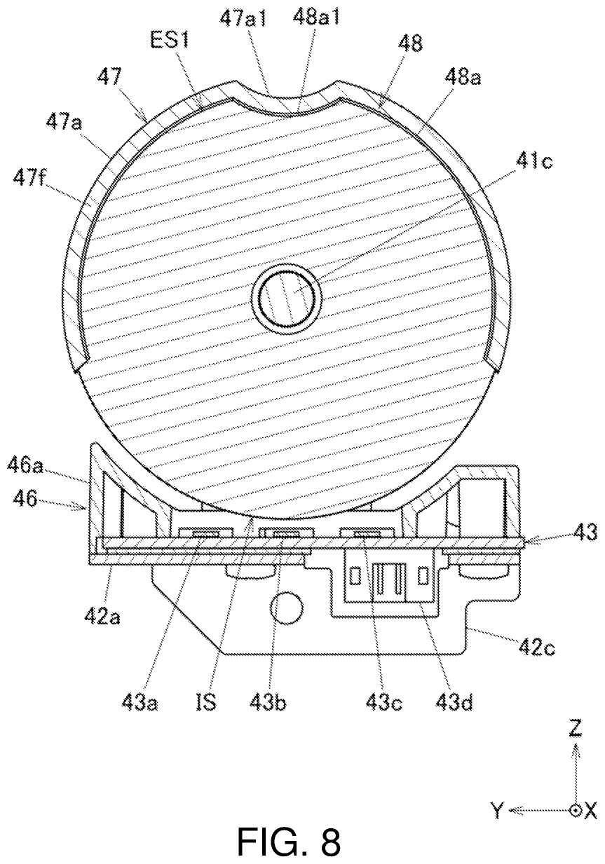

The light source substrate 43 is a flat printed circuit board arranged with its flat surfaces facing up and down. The light source substrate 43 is placed on the flat plate portion 42a of the fixing metal fitting 42 and fixed to the flat plate portion 42a by screwing. The light source substrate 43 is provided thereon with three LEDs (light source units) 43a, 43b, and 43c that emit light of different wavelength bands. The LEDs 43a to 43c are linearly arranged at regular intervals along the front-rear direction, and emit light upward from the light source substrate 43. A substantially rectangular parallelepiped light source connector 43d is provided on the lower surface of the light source substrate 43 (see FIGS. 8 and 10). A connection wiring extending from the first substrate 37a side is connected to the light source connector 43d. An insulating plate IP is sandwiched between the flat plate portion 42a of the fixing metal fitting 42 and the light source substrate 43 to insulate them from each other.

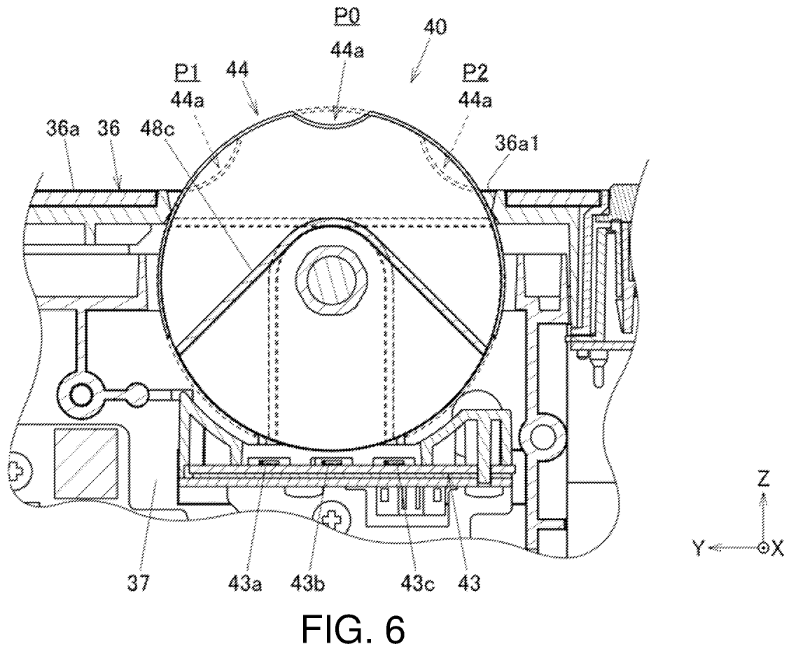

The operation wheel 44 is attached to the shaft-shaped member 41c of the variable resistor 41, and rotates together with the shaft-shaped member 41c around the axis of the shaft-shaped member 41c. A portion of the upper surface of the operation wheel 44 is provided with an operation recess 44a that is recessed in a substantially arc shape. The operation recess 44a is exposed from the operation opening 36a1 of the left case 36, and is provided so that the operator can easily rotate the operation wheel 44 by placing a finger or the like thereon. As shown in FIG. 6, the operation wheel 44 has an initial state P0 in which the operation recess 44a is directed vertically upward, and is rotatable between a first state P1 that is rotated from the initial state PO towards the front side by 45 degrees around the axis of the shaft-shaped member 41c and a second state P2 that is rotated towards the rear side by 45 degrees.

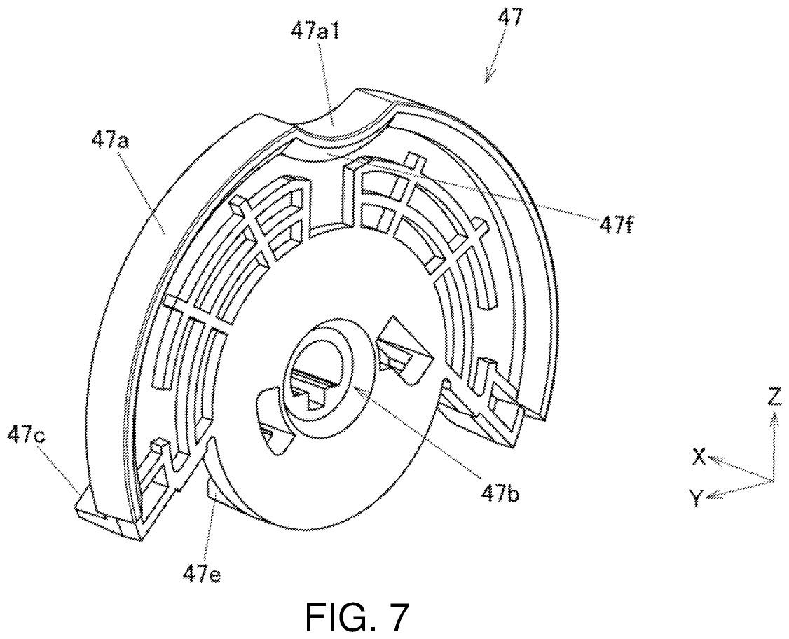

The wheel member 47 of the operation wheel 44 is made of synthetic resin, and is a generally fan-shaped plate-like member in which about ¼ of a circle is missing at the lower portion. An outer wall portion 47a that slightly extends rightward in the form of a wall is provided on the edge of the wheel member 47 except for the lower portion (see FIGS. 5 and 7). A wheel-side recessed portion 47a1, which is recessed in an arc shape and constitutes a part of the operation recess 44a, is provided in the central portion, in the front-rear direction, of the upper portion of the outer wall portion 47a. A wheel-side through hole 47b extending in the left-right direction is provided in the substantially central portion of the wheel member 47 in a substantially half-moon shape corresponding to the cross-sectional shape of the shaft-shaped member 41c. The wheel member 47 is fixed to the shaft-shaped member 41c by inserting the shaft-shaped member 41c into the wheel-side through hole 47b.

In addition, around the wheel-side through-hole 47b on the left plate surface of the wheel member 47, a wheel-side projecting portion 47c projecting leftward is provided. The wheel-side projecting portion 47c is provided in a substantially L shape when viewed from the left side so that the wheel-side through hole 47b is hidden when the wheel member 47 is viewed from above. A left plate surface of the wheel member 47 is provided with a spring fixing portion 47d projecting leftward in a substantially cylindrical shape (see FIG. 3). The wheel-side through hole 47b described above is provided so as to pass through the inside of the spring fixing portion 47d. Below the spring fixing portion 47d, a first spring abutting portion 47e is provided that protrudes leftward in a substantially flat plate shape with its plate surfaces facing generally vertically. The plate surface of the first spring contact portion 47e is gently curved so as to be convex downward.

The light guide member 48 of the operation wheel 44 has a substantially disc shape and is made of a material with excellent transmittance (for example, acrylic resin). As shown in FIG. 6, the light guide member 48 is arranged above the light source substrate 43 with slight gaps with the LEDs 43a to 43c so that light emitted from LEDs 43a to 43c enter from the lower portion of light guide member 48. The left plate surface of the light guide member 48 is attached to the plate surface located inside the outer wall portion 47a of the wheel member 47 via a double-sided adhesive tape 49, and rotates together with the wheel member 47 around the axis of the shaft-shaped member 41c. Also, a tape-side through-hole 49a through which the shaft-shaped member 41c is inserted is provided in a substantially central portion of the double-sided tape 49. Thus, the wheel member 47 is arranged on a one side of the plate surface of the light guide member 48 and supports the light guide member 48.

In the end edge (an “outer peripheral portion”) 48a of the light guide member 48, at the center of the upper portion in the front-rear direction, a light guide side recess 48a1 that is recessed in a substantially arc shape in substantially the same shape as the wheel side recess 47a1 and that constitutes a part of the operation recess 44a is provided. A light guide-side through hole 48b penetrating in the left-right direction is provided at substantially the center of the side surface of the light guide member 48. The light guide member 48 has the shaft-shaped member 41c inserted through the light guide-side through hole 48b, and rotates together with the wheel member 47 around the axis of the shaft-shaped member 41c. Around the light guide-side through hole 48b on the right plate surface of the light guide member 48, a light guide side projecting portion 48c projecting rightward is provided. The light guide side projecting portion 48c is provided in a substantially L shape when viewed from the right side so that the light guide-side through hole 48b is hidden when the light guide member 48 is viewed from above.

The torsion spring 45 has a coil spring portion 45a and a pair of urging portions 45b. The coil spring portion 45a is a coil spring, and is fixed to the spring fixing portion 47d while being wound around the outer peripheral surface of the spring fixing portion 47d. Both ends of the coil spring portion 45a extend below the spring fixing portion 47d. The pair of urging portions 45b are made of elongated cylindrical rubber members inserting the respective ends of the coil spring portion 45a therein. When the operation wheel 44 is in the initial state P0, the pair of urging portions 45b urge the first spring contact portion 47e such that the inner portions sandwich the first spring contact portion 47e while contacting the first spring contact portion 47e.

The holding member 46 is made of synthetic resin and is a member for holding the position of the torsion spring 45. The holding member 46 has a bottom portion 46a and a side plate portion 46b. The bottom portion 46a is arranged above the light source substrate 43 and is shaped so as not to cover the light emitting sides of the LEDs 43a to 43c. Both front and rear sides of the bottom portion 46a are slightly raised in a block shape, and the inner surface thereof is recessed in a curved shape along the outer peripheral surface of the operation wheel 44. The side plate portion 46b rises in a flat plate shape from the left end portion of the bottom portion 46a to the spring fixing portion 47d of the wheel member 47 with its plate surfaces oriented in the horizontal directions. At the tip of the side plate portion 46b, a wheel receiving portion 46b1 is provided which is cut out in a substantially arc shape along the outer peripheral surface of the spring fixing portion 47d. The wheel receiving portion 46b1 is provided close to the spring fixing portion 47d with a small gap therebetween.

In addition, a portion of the right side plate surface of the side plate portion 46b located below the first spring contact portion 47e is provided with a second spring contact portion 46c that protrudes to the right in a substantially flat plate shape with its plate surfaces facing in the vertical directions. The plate surface of the second spring contact portion 46c is gently curved so as to be convex downward, and has substantially the same width as the first spring contact portion 47e. When the operation wheel 44 is in the initial state P0, the pair of urging portions 45b of the torsion spring 45 are in contact with the second spring contact portion 46c while the inner sides of the urging portions 45b sandwich the second spring contact portion 46c and urge the spring contact portion 46c at a position below the first spring contact portion 47e.

In the pitch bender 40 configured as described above, when the operation wheel 44 is rotated, the shaft-shaped member 41c of the variable resistor 41 interlocks with the operation wheel 44, and the shaft-shaped member 41c rotates around its axis. When the shaft-shaped member 41c rotates, the variable resistor 41 converts the rotation angle into an electric signal and outputs the electric signal to the first substrate 37a. The electrical signal output to the first substrate 37a side is output to a control board of the electronic keyboard instrument 10 via the first substrate 37a, and is analyzed and controlled by the control board so as to apply a pitch bend effect on musical tones of the electronic keyboard instrument 10 that corresponds to the rotation angle of the operation wheel 44.

Further, in the pitch bender 40, when the operation wheel 44 is rotated to the front side, the wheel-side projecting portion 47c sandwiches the biasing portion 45b, on the front side, of the torsion spring 45, and indirectly contacts the front side end of the second spring contact portion 46c so that the rotation of the operation wheel 44 to the front side is restricted in the first state P1 in which the operation wheel 44 is rotated 45 degrees to the front side from the initial state P0. Similarly, when the operation wheel 44 is rotated to the rear side, the wheel-side projecting portion 47c sandwiches the biasing portion 45b, on the rear side, of the torsion spring 45, and indirectly contacts the rear side end of the second spring contact portion 46c so that the rotation of the operation wheel 44 to the rear side is restricted in the second state P2 in which the operation wheel 44 is rotated 45 degrees to the rear side from the initial state P0. In addition, within the range in which the operation wheel 44 can be rotated, the light source substrate 43 and the like are not visible through the operation opening 36a1 due to the wheel-side projecting portion 47c and the light guide-side projecting portion 48c provided on the operation wheel 44.

Further, in the pitch bender 40, when the operation wheel 44 is rotated, one of the pair of urging portions 45b of the torsion spring 45 contacts the first spring contact portion 47e and is separated from the second spring contact portion 46c, and the other of the pair of urging portions 45b of the torsion spring 45 contacts the second spring contact portion 46c and is separated from the first spring contact portion 47e, thereby widening the distance between the pair of urging portions 45b. Therefore, when the operation wheel 44 is rotated from the initial state P0 and a finger or the like is released from the operation recess 44a of the operation wheel 44, the elastic restoring force of the torsion spring 45 moves the operation wheel 44 to the initial state P0. That is, the position of the torsion spring 45 is held by the holding member 46 (second spring contact portion 46c).

Also, in the pitch bender 40, the light emission status of each of the LEDs 43a to 43c is controlled by the control board in accordance with the pitch bend effect imparted to the musical tone, other operation statuses, or the like. Specifically, the control board performs control to change the light emission color, light emission interval, and the like of each of the LEDs 43a to 43c. The light emitted from each of the LEDs 43a to 43c enters the light guide member 48, and is guided in the light guide member 48 to emit to the outside so that the player can visually recognize the light. This allows the player to know the musical tone control state of the electronic keyboard instrument 10. The manner of the light guidance of the light emitted from the LEDs 43a to 43c will be described in more detail later.

Next, the configuration for reflecting light by the operation wheel 44 will be described in detail. As shown in FIG. 7, the wheel member 47 is provided with an inclined surface 47f extending from the outer wall portion 47a to the inner surface (the right plate surface of the wheel member 47). As shown in FIG. 10, the inclined surface 47f is inclined with respect to the radial direction when the substantially fan-shaped wheel member 47 is viewed in a cross section cut in a plane that includes a radial direction (the direction perpendicular to the left-right direction) and the axial direction of the shaped-shaped member 41c. Specifically, the inclination angle θ1 of the inclined surface 47f with respect to the radial direction of the wheel member 47 is 45 degrees.

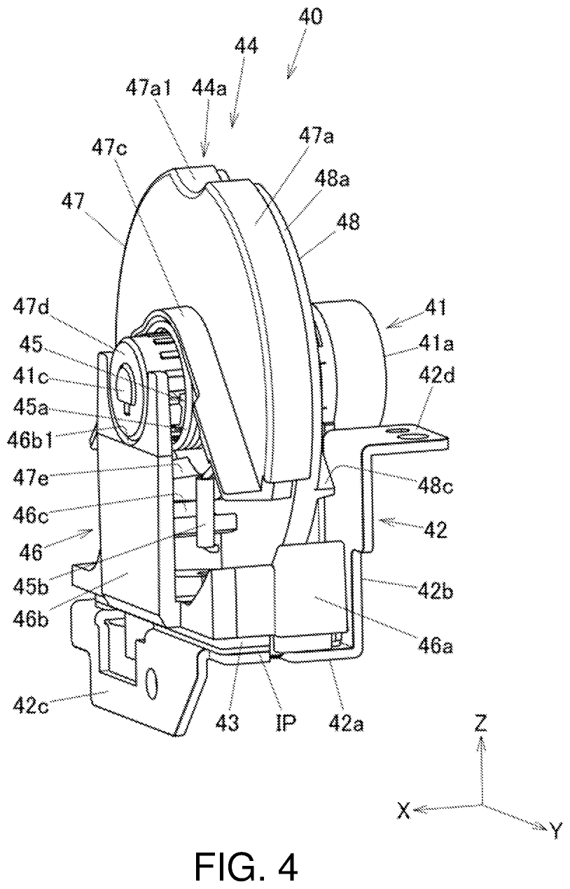

While the light guide member 48 is supported by the wheel member 47, the upper left about half portion of the outer peripheral portion 48a of the light guide member 48 is covered with the outer wall portion 47a of the wheel member 47 (see FIGS. 3 and 4). A portion of the outer peripheral portion 48a of the light guide member 48 covered with the outer wall portion 47a is a reflecting surface (reflecting member) 48d that is an inclined surface that is inclined along the inclined surface 47f of the wheel member 47. That is, the reflecting surface 48d is inclined with respect to the radial direction of the light guide member 48 (the direction perpendicular to the left-right direction). Specifically, the inclination angle θ1 of the reflecting surface 48d with respect to the radial direction of the light guide member 48 is 45 degrees (see FIG. 10). The reflecting surface 48d opposes the inclined surface 47f with a small clearance gap therebetween. The surface of the reflecting surface 48d is textured to provide an uneven surface for diffusely reflecting the light emitted from each of the LEDs 43a to 43c.

As shown in FIG. 8, the substantially disk-shaped light guide member 48 is arranged so that the lower portion of the outer peripheral portion 48a thereof overlaps the respective LEDs 43a to 43c in the vertical direction. The outer peripheral portion 48a of the light guide member 48 is textured over its entire circumference. The lower portion of the outer peripheral portion 48a of the light guide member 48 (specifically, the portion located below the light guide side projecting portion 48c) serves as an incident surface IS on which the light emitted from each of the LEDs 43a to 43c is incident. In addition, of upper portions of the outer peripheral portion 48a of the light guide member 48 (specifically, the portions positioned above the light guide side projecting portion 48c), a portion that does not face the inclined surface 47f is a first emission surface ES1 from which part of the light that is guided in the light guide member 48 is emitted.

A portion of the right plate surface of the light guide member 48 located above the light guide side projecting portion 48c serves as a second emission surface ES2 from which part of the light guided in the light guide member 48 is emitted. The second exit surface ES2 is a transparent surface. A portion of the right side plate surface of the light guide member 48, excluding the second emission surface ES2, is finely textured to prevent light from being emitted therefrom. The left plate surface of the light guide member 48 is a black printed surface so that the inside of the wheel member 47 arranged on the left side of the light guide member 48 cannot be visually recognized from the right side of the light guide member 48.

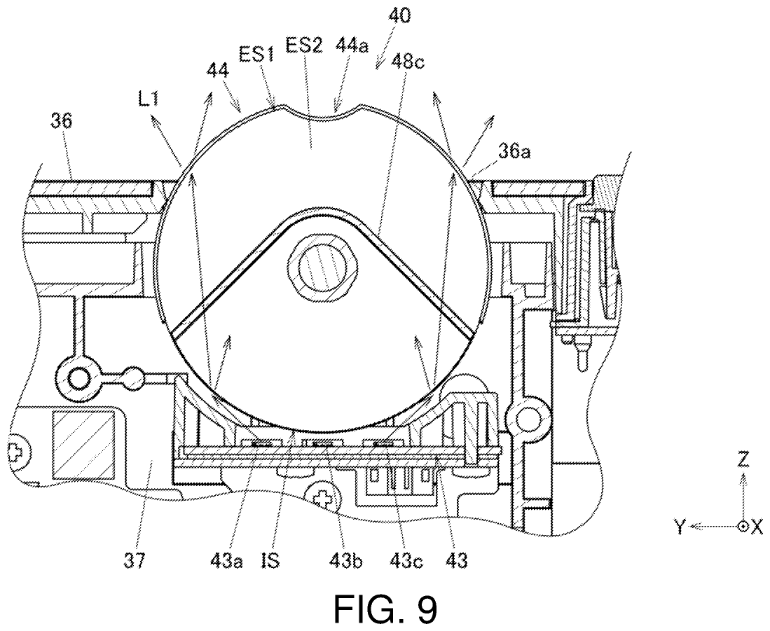

Next, optical paths of light emitted from the LEDs 43a to 43c on the light source substrate 43 will be described. As shown in FIGS. 9 and 10, light emitted from each of the LEDs 43a to 43c enters the incident surface IS of the light guide member 48. The light incident on the incident surface IS of the light guide member 48 is irregularly reflected by the incident surface IS while its intensity is suppressed due to the texturing applied to the incident surface IS, and is diffused in the light guide member 48 in its radial directions. Part of the light diffused in the radial directions within the light guide member 48 reaches the first exit surface ES1 and is emitted from the first exit surface ES1 while being diffused (hereinafter a plurality of optical paths of the light that is diffused into the light guide member through the incident surface IS and that reaches the first emission surface ES1 are collectively referred to as “first optical paths L1”) (see the solid-line arrows in FIGS. 9 and 10). Of the light emitted from the first emission surface ES1 through the first optical paths L1, the light emitted from the portion exposed from the operation opening 36a1 is emitted such that its optical axis extends along the radial direction of the light guide member 48 when the light is emitted to the outside of the opening 36a1, and therefore can be visually recognized by the player.

Some of the light diffused in the radial directions of the light guide member 48 by the incident surface IS reaches the reflecting surface 48d. The light reaching the reflecting surface 48d is diffused while being reflected by the reflecting surface 48d in the direction towards the right plate surface of the light guide member 48 (direction crossing the radial direction). Specifically, the light reaching the reflecting surface 48d has its optical axis changed by 90 degrees to the right by the reflecting surface 48d inclined at an angle of 45 degrees with respect to the radial direction, and is diffused while being reflected to the right along a direction normal to the light guide member 48, which has a substantially disc shape (in the axial direction of the shaft-like portion 41c orthogonal to the radial directions).

The light reflected to the right along the normal direction of the light guide member 48 by the reflecting surface 48d reaches the second exit surface ES2, and is emitted from the second exit surface ES2 while being diffused (a plurality of optical paths of the light diffused in the light guide member 48 by the incident surface IS, reflected by the reflecting surface 48d and reaching the second exit surface ES2 are collectively referred to as “second optical paths L2”)(see the broken-line arrows in FIGS. 9 and 10). Of the light emitted from the second emission surface ES2 through the second optical paths L2, the light emitted from the portion exposed from the operation opening 36a1 has its optical axis along the normal direction of the light guide member 48. The light is therefore emitted to the right toward the outside of the operation opening 36a1, and can be visually recognized by the player.

As described above, the pitch bender 40 according to the present embodiment includes the LEDs 43a to 43c that emit light, and the operation wheel 44 that has a substantially disc-shaped that can be rotated around the axis of the shaft-shaped member 41c of the variable resistor 41. The operation wheel 44 includes the light guide member 48 that guides the incident light from each of the LEDs 43a to 43c and that radially emits the light from the outer peripheral portion 48a, and the reflecting surface 48d that reflects a portion of the light guided in the light guide member 48 at the outer peripheral portion 48a in the axial direction that is orthogonal to the radial direction.

With the pitch bender 40 configured as described above, the player can enjoy the light that is guided by the light guide member 48 and emitted in radial directions from the outer peripheral portion 48a of the light guide member 48 (light emitted through the first optical paths L1) as well as the light reflected by the reflecting surface 48d in the light guide member 48 and emitted in the axial direction from the plate surface side of the light guide member 48 (light emitted through the second optical paths L2). Therefore, the player can obtain good visibility over a wide range compared to the conventional pitch bender 40 in which light is emitted only from the radially outer surface of the light guide member 48. As described above, in the pitch bender 40 according to the present embodiment, by controlling the light emission status of each of the LEDs 43a to 43c according to the rotation angle around the axis of the shaft-shaped member 41c, the light emission from the LEDs 43a to 43c can be visually recognized over a wide range.

Also, in the pitch bender 40, the reflecting surface 48d of the operation wheel 44 is provided in the outer peripheral portion 48a of the light guide member 48. This provides a specific configuration for the reflecting surface 48d for reflecting a portion of the light guided by the light guide member 48 at the outer peripheral portion 48a in the axial direction orthogonal to the radial direction.

Also, in the pitch bender 40, the reflecting surface 48d is inclined with respect to the radial direction of the light guide member 48. Accordingly, the light guided in the radial direction within the light guide member 48 can be reflected by the reflecting surface 48d in the axial direction perpendicular to the radial direction.

Further, in the pitch bender 40, the inclination angle θ1 of the reflecting surface 48d with respect to the radial direction of the light guide member 48 is 45 degrees. As a result, the light guided in the radial direction within the light guide member 48 can be reflected by the reflecting surface 48d such that the optical axis of the resulting light is along the normal direction of the light guide member 48.

In the pitch bender 40, the operation wheel 44 has the wheel member 47 that supports the left plate surface of the light guide member 48, and the reflecting surface 48d is provided in the light guide member 48 so as to face the inclined surface 47f of the wheel member 47. Thereby, the light guide member 48 can be supported by the wheel member 47 in the operation wheel 44. In addition, since the light guided in the radial directions within the light guide member 48 is reflected near the outer peripheral portion 48a of the light guide member 48 by the reflecting surface 48d, even when only the vicinity of the outer peripheral portion 48a of the light guide member 48 is exposed to the outside, the light reflected by the reflecting surface 48d can be easily visible to the player.

In addition, in the pitch bender 40, the reflecting surface 48d is provided with a textured surface. As a result, the light reflected by the reflecting surface 48d is diffused while being reflected so that the light reflected by the reflecting surface 48d can be easily visually recognized.

In addition, the pitch bender 40 includes three LEDs 43a to 43c that emit light of different wavelength bands, and the light guide member 48 radially guides the incident light from the three LEDs 43a to 43c. Accordingly, the light guided in the light guide member 48 and emitted from the light guide member 48 can be changed into various emission colors, and various light emission statuses corresponding to various operations of the operation wheel 44 can be obtained.

The electronic keyboard instrument 10 according to this embodiment includes the above-described pitch bender 40. Because of this, of the light rays emitted from the LEDs 43a to 43c, the player can not only visually recognize the light emitted through the first optical paths L1 from above the electronic keyboard instrument 10, but also recognize the light emitted through the second optical paths L2 from the right side of the electronic keyboard instrument 10 as well. Therefore, it is possible to obtain good visibility over a wide range compared to the conventional electronic keyboard instrument 10, and it is possible to realize the electronic keyboard instrument 10 in which the player can visually recognize the light emitted from the LEDs 43a to 43c according to the operations of the operation wheel 44 over a wide range.

Further, in the embodiment described above, the configuration in which the light guide member 48 is provided with the reflecting surface 48d, which is a reflecting member for reflecting the incident light from each of the LEDs 43a to 43c, is described. Alternatively, the reflecting member can be provided on an inclined surface of the wheel member 47.

It should be noted that the embodiments described above are presented as examples and are not intended to limit the scope of the invention. These novel embodiments can be implemented in various other forms, and various omissions, replacements, and modifications can be made without departing from the spirit of the invention. These embodiments and their modifications are included in the scope and gist of the invention, and are included in the scope of the invention described in the claims and its equivalents. For example, in the above embodiments, the pitch bender was exemplified as the manipulator, but other manipulators such as a modulation wheel may be used. Further, for example, in the above-described embodiments, an electronic keyboard instrument is used as an example of an electronic musical instrument, but other electronic musical instruments that do not have a keyboard may be used.

What is claimed is:

1. A manipulator, comprising:
a light source that emits light; and
an operation member rotationally operatable around an axis by a user, the operation member having a substantially disk shape and including a light guide member that guides light incident from the light source and transmits the light to an outside in radical directions of the substantially disk shape from an outer peripheral portion thereof, and a reflecting member reflecting a portion of the light guided by the light guide member in a direction perpendicular to the radial directions at said outer peripheral portion.

2. The manipulator according to claim 1, wherein said reflecting member is provided on said outer peripheral portion of said light guide member.

3. The manipulator according to claim 1, wherein said reflecting member has a reflecting surface inclined with respect to said radial directions.

4. The manipulator according to claim 2, wherein said reflecting member has a reflecting surface inclined with respect to said radial directions.

5. The manipulator according to claim 3, wherein in a cross section taken in a plane that includes said axis, an inclination angle of said reflecting surface with respect to the radial direction in the cross section is 45 degrees.

6. The manipulator according to claim 4, wherein in a cross section taken in a plane that includes said axis, an inclination angle of said reflecting surface with respect to the radial direction in the cross section is 45 degrees.

7. The manipulator according to claim 1,
wherein the operation member further includes a wheel member arranged on one plate surface side of the light guide member, and
wherein the reflecting member is provided on the light guide member so as to face an inclined surface of the wheel member.

8. The manipulator according to claim 2,
wherein the operation member further includes a wheel member arranged on one plate surface side of the light guide member, and
wherein the reflecting member is provided on the light guide member so as to face an inclined surface of the wheel member.

9. The manipulator according to claim 3,
wherein the operation member further includes a wheel member arranged on one plate surface side of the light guide member, and
wherein the reflecting member is provided on the light guide member so as to face an inclined surface of the wheel member.

10. The manipulator according to claim 1, wherein said reflecting member is provided with an uneven surface on which texturing is applied.

11. The manipulator according to claim 1,
wherein the light source includes a plurality of light emitting devices emitting respectively light of different wavelengths, and
wherein the light guide member directs light from each of the plurality of light emitting devices in the radial directions.

12. An electronic musical instrument comprising:
the manipulator as set forth in claim 1; and
an control board connected to the manipulator and causing electronically synthesized sound to be generated and output.

13. An electronic musical instrument comprising:
the manipulator as set forth in claim 2; and
an control board connected to the manipulator and causing electronically synthesized sound to be generated and output.

14. An electronic musical instrument comprising:
the manipulator as set forth in claim 3; and
an control board connected to the manipulator and causing electronically synthesized sound to be generated and output.

15. An electronic musical instrument comprising:
the manipulator as set forth in claim 4; and
an control board connected to the manipulator and causing electronically synthesized sound to be generated and output.
